(19) United States
(12) Patent Application Publication
(10) Pub. No.: US 2011/0134884 A1
(43) Pub. Date: Jun. 9, 2011

(54) METHOD FOR CONTROLLING COMMUNICATION, WIRELESS DEVICE, AND BASE STATION

(75) Inventors: Kotaro Shiizaki, Kawasaki (JP); Kazuo Kawabata, Kawasaki (JP)

(73) Assignee: FUJITSU LIMITED, Kawasaki-shi (JP)

(21) Appl. No.: 13/027,663

(22) Filed: Feb. 15, 2011

Related U.S. Application Data
(63) Continuation of application No. PCT/JP2008/065960, filed on Sep. 4, 2008.

(51) Int. Cl. H04W 76/02; H04W 36/08

(52) U.S. Cl. 370/331; 370/328

(57) ABSTRACT

A wireless device transmits first information, representing whether the wireless device expects to receive data from a base station, to the base station before receipt of an inquiry from the base station about whether the wireless device expects to receive the data, and on receipt of the inquiry from the base station, restricts transmission of a response to the inquiry to the base station if the first information is not changed.

### CROSS-REFERENCE TO RELATED APPLICATION

This application is a continuation Application of a PCT international application No. PCT/JP2008/065960 filed on Sep. 4, 2008 in Japan, the entire contents of which are incorporated by reference.

### FIELD

The embodiments discussed herein are related to a method for controlling communication, a wireless device, and a base station.

### BACKGROUND

Multimedia Broadcast and Multicast Service (MBMS) is to be adopted to the next-generation wireless communication and is developing in the Long Term Evolution (LTE) standardizing committee of the Third Generation Partnership Project (3GPP).

MBMS communication is so-called point-to-multipoint (PtM) communication, in which, for example, a single wireless base station transmits the common data (contents) to a number of User Equipments (UEs). The data may include multimedia data, such as music or picture data.

In MBMS, the Base Station (BTS etc.) transmits information notifying (the start of) providing service from the BTS. This information is transmitted through a channel called MICH (MBMS notification Indicator Channel). A UE receives the information of the MICH and thereby recognizes the start of the service provided by the BTS that transmitted the information.

In succession, the BTS further transmits information of an MCCH (MBMS point-to-multipoint Control Channel) in order to grasp the number of UEs that expect to receive the service of the BTS. The information of the MCCH includes information about the contents of the service that the BTS provides and information to request the UE to respond to this information if the UE expects to be provided with the service.

Upon receipt of the information of the MCCH, a UE recognizes the contents of the service that the UE can be provided with, and, if the UE expects to receive the service, notifies (responds to) the BTS that the UE expects to receive the service. The response can be notified to the BTS through a Random Access Channel (RACH) serving as an example of the uplink (UL) channels.

The BTS recognizes the number of UEs that expect to receive the service by counting the number of responses to information of the MCCH which responses are received by the BTS.

[Patent Document 1] Japanese Laid-open Patent Publication No. 2006-345298

[Non-Patent Document 1] 3GPP TS25.211 V8.1.0

Conventionally, all UEs that expect to receive the MBMS service respond to the received information of the MCCH, which may increase the load on the UL channel (e.g., RACH) and may further increase the load on the BTS.

### SUMMARY

According to an aspect of the embodiments, a method includes a method for controlling communication in a wireless communication system in which abase station transmits data to a wireless device, the method including: at the wireless device, transmitting first information, representing whether the wireless device expects to receive the data, to the base station before receipt of an inquiry from the base station about whether the wireless device expects to receive the data, and upon receipt of the inquiry from the base station, restricting transmission of a response to the inquiry to the base station if the first information is not changed.

(2) According to an aspect of the embodiments, an apparatus includes a wireless device used in a wireless communication system in which a base station transmits data to the wireless device, the wireless device including: a transmitter that transmits first information, representing whether the wireless device expects to receive the data, to the base station before receipt of an inquiry from the base station about whether the wireless device expects to receive the data; and a controller that restricts transmission of a response to the inquiry that the wireless device receives from the base station after the transmitter transmits the first information to the base station if the first information is not changed.

(3) According to an aspect of the embodiments, an apparatus includes a base station used in a wireless communication system in which the base station transmits data to a wireless device, the base station including: a receiver that receives first information, which represents whether wireless device expects to receive the data and which is transmitted from the wireless device before the base station transmits to an inquiry about whether the wireless device expect to receive the data to the wireless device, and that receives second information transmitted from the wireless device after the base station transmits the inquiry to the wireless device if the first information is not changed; a manager that manages, on the basis of the first information and the second information received from the wireless device, whether the wireless device expects to receive the data from the base station; and a transmitter that transmits the data under the control of the manager.

The object and advantages of the embodiment will be realized and attained by means of the elements and combinations particularly pointed out in the claims. It is to be understood that both the foregoing general description and the following detailed description are exemplary and explanatory and are not restrictive of the embodiment, as claimed.

### BRIEF DESCRIPTION OF THE DRAWINGS

FIG. 1 is a sequence diagram illustrating an example of establishing MBMS communication (link) and counting UEs;

FIG. 2 is a diagram illustrating an example of MICH transmission;

FIG. 3 is a diagram illustrating an example of the format of MICH;

FIG. 4 is a diagram schematically illustrating an example of MCCH transmission:

FIG. 5 is a diagram illustrating an example of the format of MCCH;

FIG. 6 is a sequence diagram illustrating an example of MBMS communication and counting UEs according to a first embodiment;

FIG. 7 is a diagram illustrating an example of the format of an existing RACH response (msg2);

FIG. 8 is a diagram illustrating an example of the format of a RACH response (msg2) used in the first embodiment;

FIG. 9 is a diagram schematically illustrating an example of an inquiry of MBMS receiving requirement and a response to the inquiry in the sequence of FIG. 6;

FIG. 10 is a diagram schematically illustrating of an example of transmitting an MCCH response only from UEs that change the MBMS receiving requirement;

FIG. 11 is a diagram illustrating an example of the format of a MCCH response;

FIG. 12 is a diagram illustrating an example of another format of a MCCH response;

FIG. 13 is a diagram schematically illustrating an example of, when a UE of the first embodiment is being powered off or changing the cell, notifying the power-off or the cell change to the BTS beforehand;

FIG. 14 is a sequence diagram illustrating a modification of the sequence of FIG. 6;

FIG. 15 is a block diagram schematically illustrating an example of the configuration of the BTS of the first embodiment;

FIG. 16 is a diagram illustrating an example of a management table that the BTS of FIG. 15 manages;

FIG. 17 is a diagram illustrating an example of updating the management table under the state of FIG. 10;

FIG. 18 is a diagram illustrating an example of updating the management table under the state of FIG. 13; and

FIG. 19 is a block diagram schematically illustrating an example of the configuration of the UE of the first embodiment.

### DESCRIPTION OF EMBODIMENTS

Hereinafter, description will now be made in relation to an embodiment with reference to accompanying drawings. However, the embodiment to be detailed below is merely example, so there is no intention of excluding another embodiments and variations and application of techniques that are not mentioned in this specification. In other words, various changes and modifications (e.g., combination of the embodiments and the modifications) can be suggested without departing from the spirit the embodiment.

### (1) First Embodiment

(1.1) Establishment of MBMS Communication and Counting:

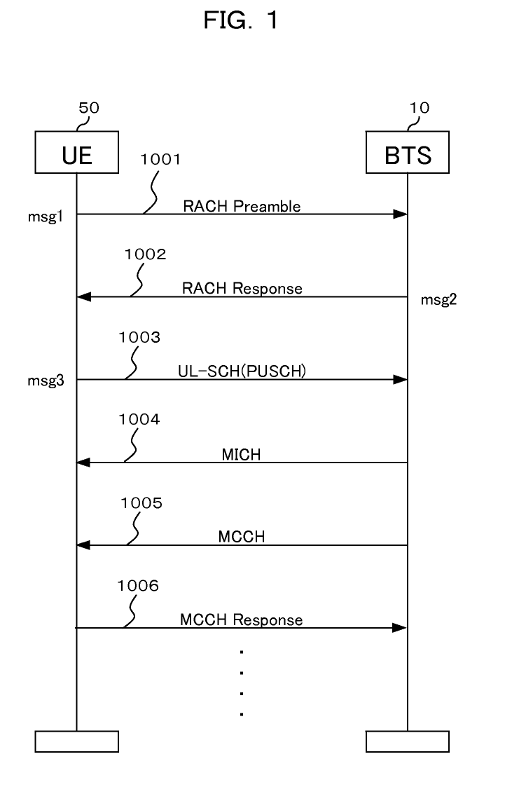

To begin with, description will now be made in relation to establishment of MBMS communication (link) and counting the number of UEs with reference to sequence diagram FIG. 1.

A UE communicates with one or more core networks (e.g., Internet) through a Radio Access Network (RAN) including a base station (BTS etc.) serving as an entity. A UE is satisfactorily a wireless communication unit capable of transmitting and receiving at least one of voice and data to and from a RAN. An example of a UE is a mobile telephone, a laptop PC equipped with a wireless interface, a wireless device mounted to a vehicle. A UE is not limited to a mobile device, and may be a fixed wireless device.

In FIG. 1, in establishing communication (link) with a BTS 10, a UE 50 serving as an example of a wireless device transmits a RACH preamble (msg1) to the BTS 10 (step 1001).

Upon receipt of the RACH preamble, the BTS 10 transmits a RACH response (msg2) to the UE 50 (step 1002).

Upon receipt of the RACH response, the UE 50 transmits an UL scheduling request (msg3) to the BTS 10 through, for example, an UL Shared channel (UL-SCH) (step 1003). An UL-SCH is exemplified by a PUSCH (Physical Uplink Shared Channel).

Upon receipt of the scheduling request, the BTS 10 allocates a wireless resource (e.g., band) to forthcoming communication with the UE 50.

After the allocation, the UE 50 comes into a state being able to communicate with the BTS 10 using the allocated wireless resource (a link established state).

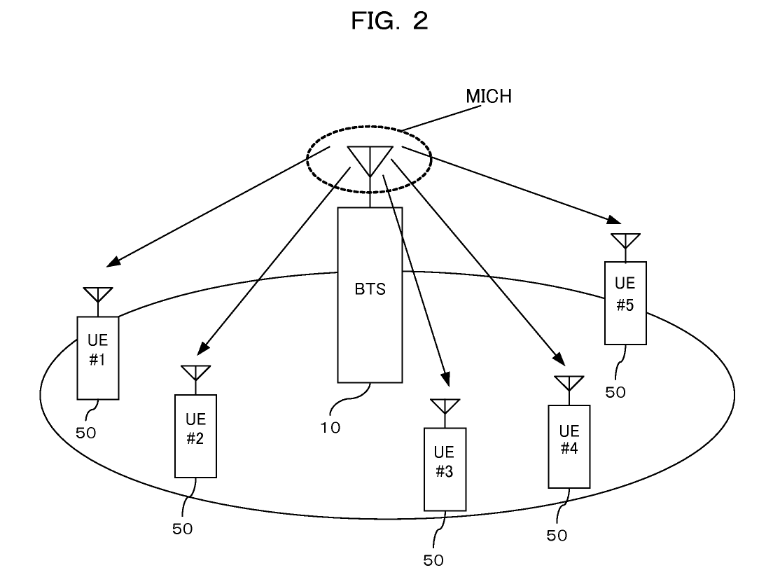

Then, the BTS 10 transmits information of the MICH to the UE 50 so that the start of the MBMS service is notified to the UE 50 (step 1004). The MICH is one of the shard channels. As illustrated in FIG. 2, through the MICH, all the UEs 50, including ones in an idle state, under the control of the BTS 10 are notified (the start of) providing of the MBMS, which thereby collects UEs 50 that expect to participate in (receive) the MBMS. Using a broadcast channel as the above shared channel makes it possible to notify (the start of) providing to UEs 50 even in an idle state or a dormant state.

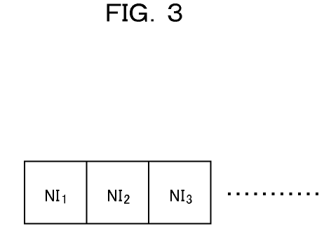

FIG. 3 illustrates an example of a format of the MICH. In FIG. 3, NI₁, NI₂, NI₃ . . . represent various Notification Indicators, which are set in accordance with the contents and the kinds of the MBMS service. The size of the MICH is about a couple of hundreds bits (e.g., 300 bits). After the establishment of communication link (RACH) between the BTS 10 and the UE 50, an NI can be transmitted through a channel other than the MICH.

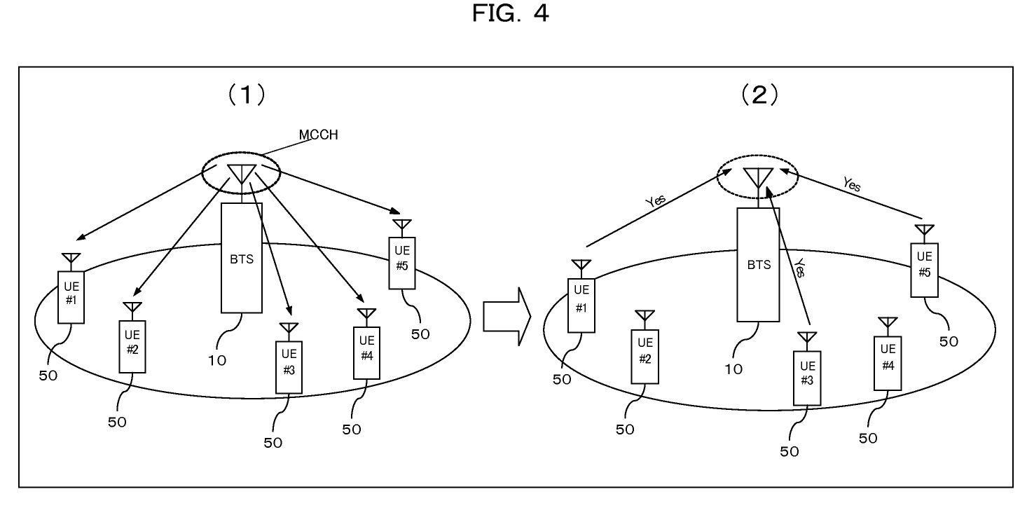

Next, the BTS 10 transmits the information of the MCCH (step 1005, see (1) in FIG. 4) to notify the contents of the MBMS service to UEs 50 under the control of the BTS 10 itself and request the respective UEs 50 if expect to receive the MBMS service to respond to the information. Namely, the information of the MCCH serves as an inquiry about whether or not each UE 50 under the control of the BTS 10 expects to receive the MBMS contents.

The MCCH is an individual channel mapped by the MICH. Through this individual channel, information (e.g., service information for each UE 50) which may cause a problem if transmitted through a shared channel can be individually (securely) transmitted to the corresponding UE 50.

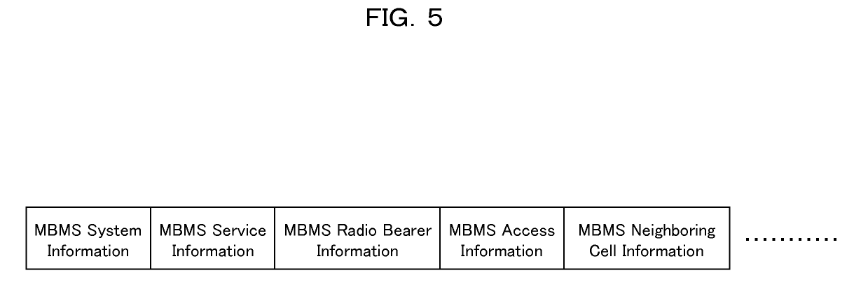

FIG. 5 illustrates an example of the format of the MCCH.

The field “MBMS System Information” includes MCCH scheduling information and the configuration information of a wireless bearer in which the MCCH is to be mapped.

The field “MBMS Service Information” includes an identifier (ID) of an available MBMS service and a PtM (Point to Multipoint) indicator.

The field “MBMS Radio Bearer Information” is information set when PtM communication is carried out, and includes wireless bearer information of an MTCH (MBMS Traffic Channel).

The field “MBMS Access Information” includes the ID of the MBMS service that requires counting the number of UEs that expect to receive the MBMS service and a probability factor.

The field “MBMS Neighboring Cell Information” includes wireless bearer information of the MTCH of an neighboring cell (BTS).

Upon receipt of the information of the MCCH, the UE 50 that expects to receive the MBMS service returns the response (the MCCH response) to the BTS 10 to thereby request transmission of the MBMS contents (see step 1006, (2) of FIG. 4). The response to the reception of the information of the MCCH does not always have to be after the establishment of the RACH. Alternatively, the UE 50 in an idle state may receive the information of the MICH and further receive the MCCH under the instructions of the received MICH before the establishment of the RACH. Accordingly, the UE 50 satisfactorily returns the response to the received MCCH through, for example, the RACH.

The BTS 10 counts the number of received MCCH responses to thereby recognize the number of UEs 50 that expect to receive the MBMS service. This counting can be carried out through the BTS 10 by a non-illustrated upper layer (upper unit), such as an RNC (Radio Network Controller) and an MBMS-GW (Gateway).

If all the UEs 50 that expect to receive the MBMS service transmit responses (MCCH responses) to the MCCH all at once, the communication load on the wireless UL channel increases. For example, assuming that the responses are transmitted through the RACH, the RACH may be cluttered, resulting in possible increase in load and in delay.

For the above, the first embodiment, each UE 50 notifies the BTS 10 of whether the UE 50 expects to receive MBMS contents (MBMS receiving requirement information) before the UE 50 receives information of the MCCH. Then, upon receipt of the information of the MCCH (inquiry about whether the UE 50 expects to receive the MBMS contents), each UE 50 responds (MCCH response) to the inquiry only when the MBMS receiving requirement information (first information) that the UE 50 previously notified to the BTS 10 is changed.

Specifically, if a UE 50 makes a change in the MBMS receiving requirement information previously notified, the UE 50 transmits an MCCH response (second information serving as MBMS receiving requirement information) to the BTS 10; if the UE 50 does not make a change in MBMS receiving requirement information previously notified, the UE 50 restricts transmission of the MCCH response to the BTS 10. This “restriction” means stopping transmission of the MCCH response or permitting transmission, using a less data amount than that of a normal response.

This configuration causes a UE 50 to respond to the inquiry using a normal amount of information (i.e., the second information) only when the MBMS receiving requirement information (i.e., the first information) that the UE 50 notified to the BTS 10 before receiving the information about the MCCH is changed. Consequently, communication load of the wireless UL channel and processing load of UL at the BTS 10 can be stochastically reduced.

Here, a timing at which a UE 50 transmits MBMS receiving requirement information to the BTS 10 beforehand can be during the sequence of establishing the communication link between the UE 50 and the BTS 10. An example of the sequence of establishing the communication link is a random access sequence for initial connection.

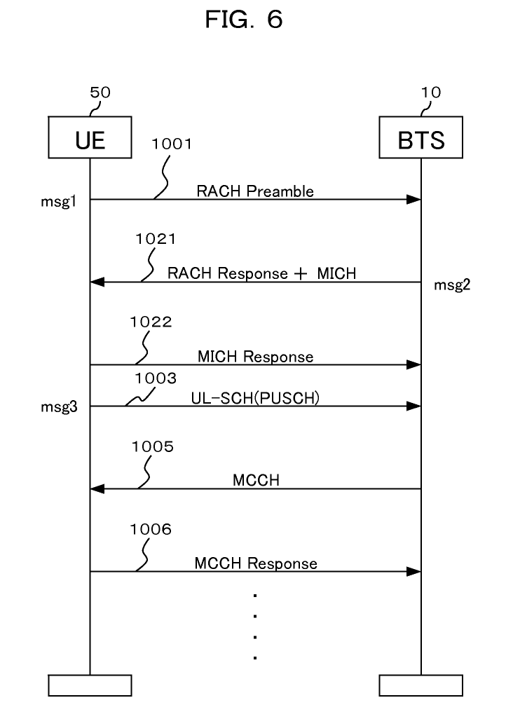

As exemplarily illustrated in the example of FIG. 6, the BTS 10 transmits information of the MICH (notification indicators) to the UE 50 during a random access sequence, and the UE 50, upon receipt of the information of the MICH, transmits the response (the MICH response) to the BTS 10. The UE 50 can put the MBMS receiving requirement information, serving as an example of the first information, into the response to be transmitted to the BTS 10.

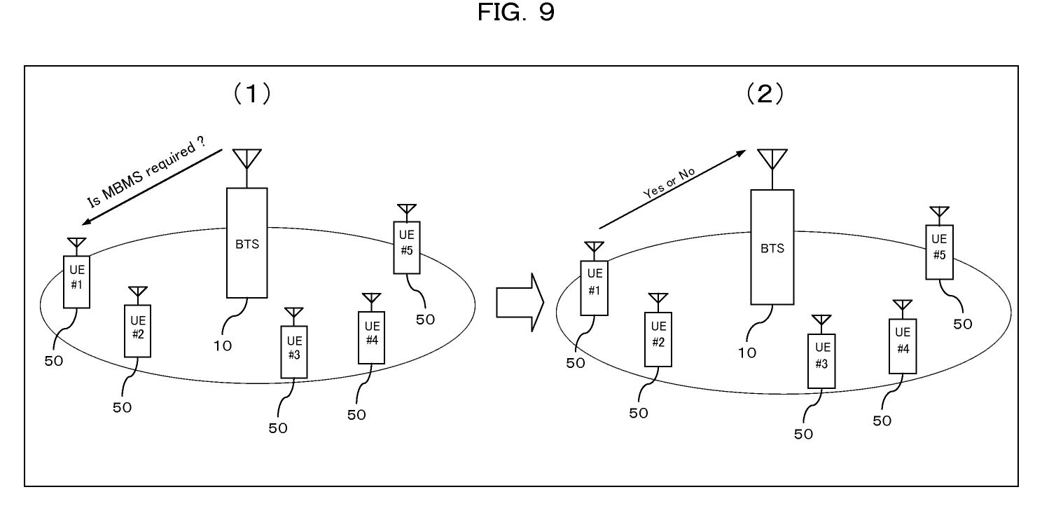

As illustrated in FIG. 6 (step 1021) and (1) of FIG. 9, the BTS 10 can put the information about the MICH into the response (RACH response (msg2)) to the RACH preamble received from the UE 50 and transmit the RACH response to the UE 50.

Including the information of the MICH in the RACH response eliminates the requirement that the UE 50 always monitors reception of the MICH. Accordingly, since there is no requirement to prepare MICHs one for each individual UE 50 as performed in the example of FIG. 1, the extra wireless resource can be used for other data transmission. However, it should be noted that the information of the MICH can be transmitted independently of the RACH response (msg2) by broadcasting, for example.

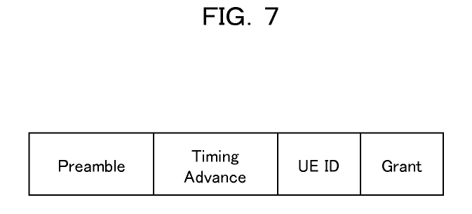

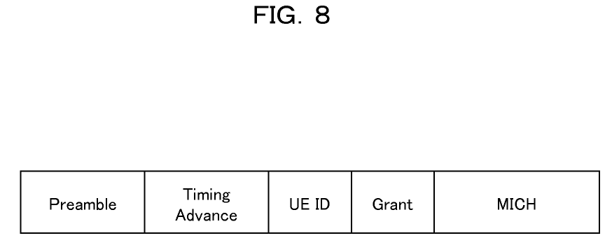

FIG. 8 illustrates an example of the format of a RACH response of the first embodiment. The field “Preamble” represents synchronization information; the field “Timing Advance” is information used by the BTS 10 for assigning a UL transmission timing of a UE 50; the field “UE ID” represents identification information of a UE 50; the field “Grant” represents information of permitting UL transmission; and the field “MICH” includes a proper number of notification indicators (NI) as illustrated in the example of FIG. 3. FIG. 7 illustrates an example of the format of an conventional RACH response.

In the meantime, as illustrated in FIG. 6 (step 1022) and (2) of FIG. 9, upon receipt of the RACH response including the information of the MICH from the BTS 10, the UE 50 transmits (notifies) the receiving requirement information of the MBMS contents in the form of being included in the MICH response to the BTS 10. The NIs included in the MICH can be regarded as respective different MBMS contents each in which abstract of the contents and information of the mapping destination of the MCCH are stored. Accordingly, the MICH response satisfactorily includes information which NI the UE 50 expects. An example of NIs is illustrated in Table 1 below.

TABLE 1
MICH Response

| | MBMS Receiving |
|---|---|
| NI | Requirement |
| 1 | Required |
| 2 | Not required |
| 3 | Not required |
| . . . | . . . |

The receiving requirement information may be transmitted, being included in the message part of the RACH or may be transmitted, being included in the scheduling request (msg3) to be transmitted using the UL-SCH (PUSCH) as described above. Alternatively, the information may be included in signaling of the upper layer.

Upon receipt of the MBMS receiving requirement information, the BTS 10 manages the received information for each individual UE 50 through the use of the “UE ID” detailed above.

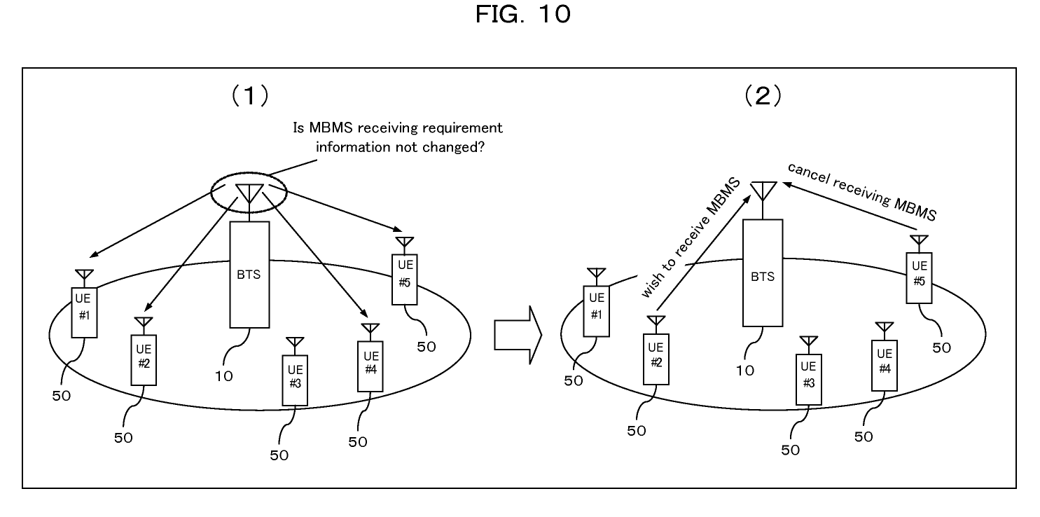

The BTS 10 transmits information of the MCCH to the UEs 50 under the control of the BTS 10 itself before the start of the MBMS service (i.e., transmission of the MBMS contents). The transmission of the information of the MCCH also serves as a confirmation (inquiry) about whether the MBMS receiving requirement information of each individual UE 50 is changed (see (1) in FIG. 10). The BTS 10 can periodically make the confirmation (inquiry) to each UE 50 under the control of the BTS 10 through polling.

Upon receipt of the information of the MCCH from the BTS 10, the UE 50 confirms whether the MBMS receiving requirement information that the UE 50 previously transmitted to the BTS 10 is changed and, if the information is changed, transmits updated MBMS receiving requirement information (i.e., the second information) to the BTS 10.

Specifically, as exemplarily illustrated in (2) of FIG. 10, if a UE 50 which previously notified the BTS 10 of not expecting to receive the MBMS contents changes to expecting to receive the contents afterwards, the UE 50 (UE#2) notifies the BTS 10 of the change (expecting to receive the contents).

Conversely, a UE 50 (UE#5) which previously notified the BTS 10 of expecting to receive the MBMS contents but changes to not expecting to receive the contents transmits the BTS 10 of the change (cancelling the receiving the contents).

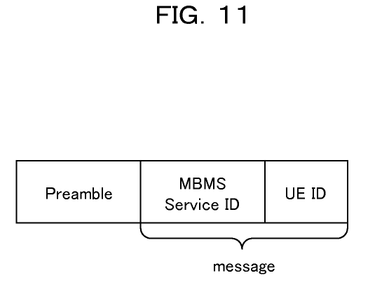

The above changes can be notified through the use of the MCCH response destined for the BTS 10. FIG. 11 illustrates an example of the format of the MCCH response using an UL RACH. The format illustrated in FIG. 11 includes a preamble field, an MBMS service ID field, and a UE ID field. A UE 50 which changes the MBMS receiving requirement information sets the ID of a MBMS service that the UE 50 expects into the MBMS service ID field and concurrently sets the own ID in the UE ID field.

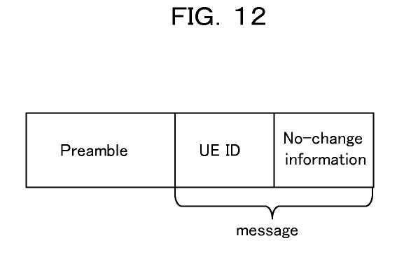

A UE 50 that does not change the MBMS receiving requirement information previously transmitted does not have to make this notification (response). However, such a UE 50 can notify the BTS 10 of no change in the previous information through the use of an MCCH response. FIG. 12 illustrates an example of the format of the MCCH response of this case, using the UL RACH.

The MCCH response illustrated in FIG. 12 exemplarily includes a preamble field, a UE ID field, and information field indicating no change. A UE 50 does not change the MBMS receiving requirement information sets information indicating no change (for example, one bit) into the information field, and concurrently sets the own ID in the UE ID field.

In this case, since the MBMS service ID has already been notified to the BTS 10 in the MICH response, there is no requirement to notify the MBMS service ID (in other words, there is no need to prepare the MBMS service ID field) again. Accordingly, the MCCH response of FIG. 12 can reduce the amount of information to be transmitted to the BTS 10 as compared with that illustrated in FIG. 11.

In the preamble fields in the formats illustrated in FIGS. 11 and 12, predetermined synchronization information is set.

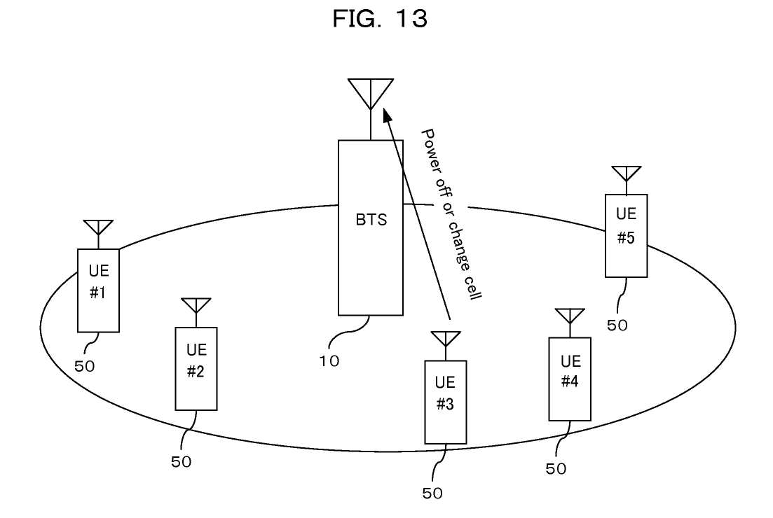

As exemplarily illustrated in FIG. 13, when a UE 50 is being powered off or changes the BTS cell that the UE 50 is currently connecting (i.e., leaving the present cell) due to handover, the UE 50 can notify the BTS 10 the powering off or the handover the present cell in advance.

Thereby, even if a UE 50 which has no change in the MBMS receiving requirement information and which does not transmit the MCCH response is present, the BTS 10 can recognize a UE 50 to which there is no need to transmit MBMS contents any longer.

Accordingly, the BTS 10 can stop the transmission of the MBMS contents to the UE 50 in question, avoiding unnecessary transmission of MBMS contents.

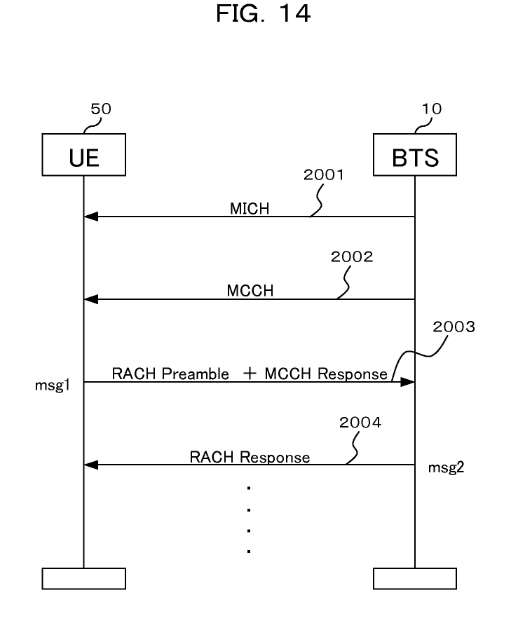

Furthermore, as exemplarily illustrated in FIG. 14, the UE 50 that previously received information of the MICH and the MCCH from the BTS 10 (see step 2001 and step 2002) is in a state of being able to transmit an MCCH response to the BTS 10. Accordingly, the UE 50 transmits the MCCH response (change in the MBMS receiving requirement) to the BTS 10 concurrently with the transmission of the RACH preamble (step 2003). Upon receipt of the RACH preamble and the MCCH response, the BTS 10 transmits the RACH response to the UE 50 (step 2004).

Hereinafter, detailed description will now be made in relation to the configurations (functions) of the BTS 10 and the UE 50 that realize the above MBMS communication control.

(1.2) BTS 10

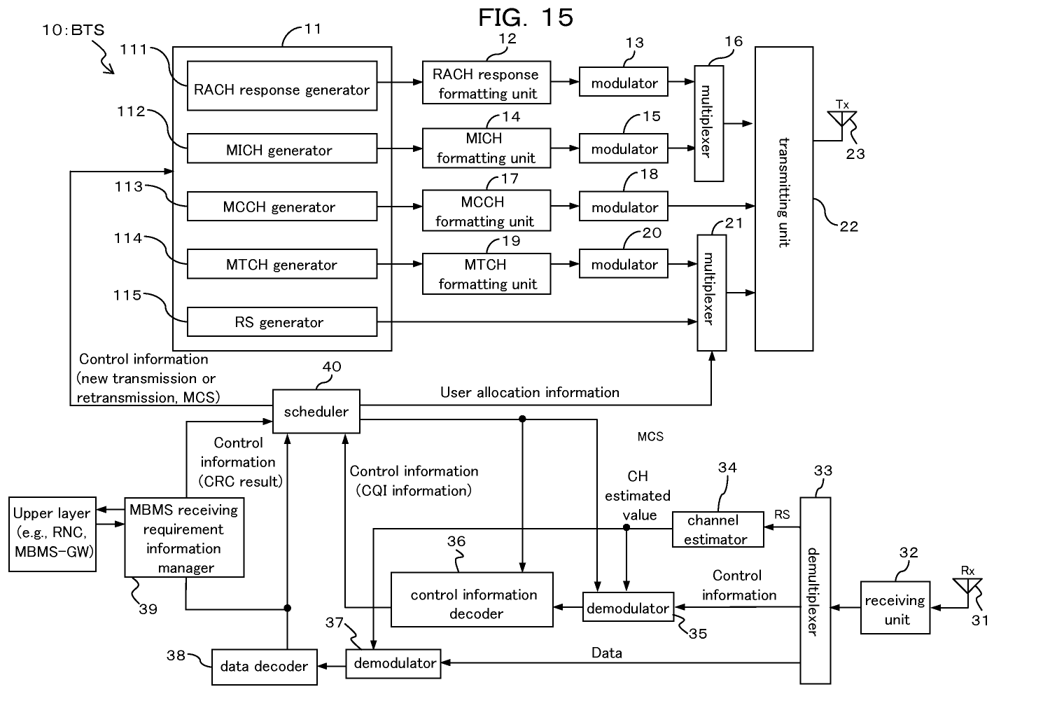

FIG. 15 is a block diagram illustrating an example of the configuration of the BTS 10 of the first embodiment. The BTS 10 illustrated in FIG. 15 includes, a generator 11, a RACH response formatting unit 12, an MICH formatting unit 14, an MCCH formatting unit 17, an MTCH formatting unit 19, modulators 13, 15, 18, and 20, multiplexers 16 and 21, a transmitting unit 22, and a transmitting antenna 23, which collectively serve as an example of a transmission processor. Furthermore, the generator 11 includes a RACH response generator 111, an MICH generator 112, an MCCH generator 113, an MTCH generator 114, and an RS generator 115.

The BTS 10 further includes, a receiving antenna 31, a receiving unit 32, a demultiplexer 33, a channel (CH) estimator 34, a demodulator 35, a control information decoder 36, a demodulator 37, and a data decoder 38, which collectively serve as an example of a reception processor.

The BTS 10 still further includes an MBMS receiving requirement information manager 39 and a scheduler 40, which collectively serve as an example of a controller.

The receiving antenna 31 receives a wireless UL signal that the UE 50 transmits and input the received signal into the receiving unit 32.

The receiving unit 32 performs a predetermined wireless reception processing on the wireless UL signal that the receiving antenna 31 receives. The reception processing exemplarily includes low-noise amplification, frequency conversion to the baseband frequency (i.e. down conversion) and Analog-to-Digital (AD) conversion.

The demultiplexer 33 separates a Reference Signal (RS), a control signal, and data from a received baseband signal obtained by the receiving unit 32. The RS is a signal already known to both the UE 50 and the BTS 10, and is input into the channel estimator 34. The control information includes, for example, CQI (Channel Quality Indicator) information, a result of CRC (Cyclic Redundancy Check) (i.e., an ACK/NACK signal), and is input into the demodulator 35. The data includes UL data (control data, voice data, and picture data) that the UE 50 transmits and is input into the demodulator 37.

The channel estimator 34 estimates a channel value representing an UL channel response between the UE 50 and the BTS 10 on the basis of the RS. The channel estimated value is provided to both the demodulator 35 and the demodulator 37.

The demodulator 35 demodulates the control information obtained by the demultiplexer 33 in a demodulation scheme complying with the UL modulation scheme that the UE 50 adopts on the basis of the channel estimated value obtained by the channel estimator 34 and MCS (Modulation and Coding Scheme) information provided from the scheduler 40.

The control information decoder 36 decodes the control information demodulated in the demodulator 35 in a decoding scheme and at an decoding ratio which comply with an encoding scheme and an encoding ratio that the UE 50 adopts on the basis of the MCS information provided from the scheduler 40. The UE 50 can adopt an error correction encoding scheme such as turbo encoding scheme and can adopt an error correction decoding scheme complying with the encoding scheme. The encoded control information is provided to the scheduler 40.

The demodulator 37 demodulates the received UL data obtained by the demultiplexer 33 on the basis of the channel estimated value from the channel estimator 34 and the MCS information from the scheduler 40. The received data includes, for example, an RACH preamble, an MICH response, information of the UL-SCH, an MCCH response, information of powering-off operation of the UE 50.

The data decoder 38 decodes the received data demodulated in the demodulator 37 on the basis of the MCS information from the scheduler 40. An error correction decoding scheme can also apply to the decoding scheme of the received data. The result of decoding is then subjected to CRC processing, the result of the processing serves as one piece of the control information and is provided to the scheduler 40. If the result of decoding includes an MICH response, the MBMS receiving requirement information is extracted from the response and is sent to the MBMS receiving requirement information manager 39.

The block including the elements represented by reference numbers 31 through 38 serves as an example of a receiver that receives first information (e.g., MICH response) which represents whether a UE 50 expects to receive the MBMS contents and which the UE 50 transmits before the BTS 10 transmits an inquiry (e.g., MCCH information) about whether the UE 50 expects to the receive the MBMS contents to the UE 50, and that receives second information (e.g., MCCH response), which a UE 50 that changes the first information after the transmission of the inquiry from the BTS 10 transmits and which represents whether the UE 50 expects to receive the MBMS contents.

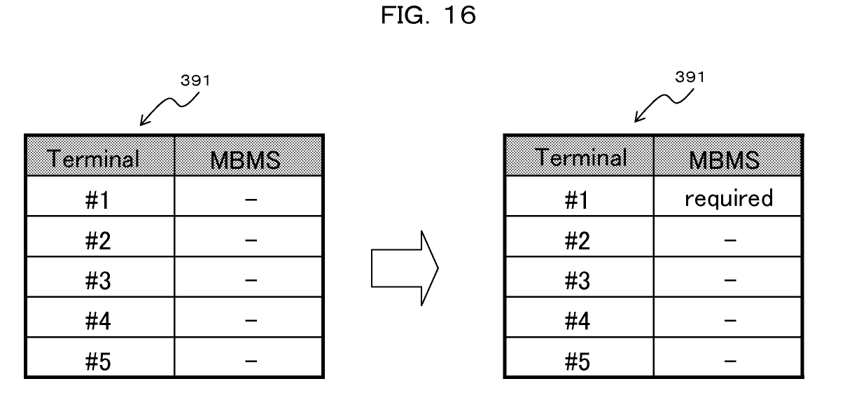

The MBMS receiving requirement information manager (hereinafter simply called manager) 39 manages the MBMS contents receiving requirement information for each UE 50 (i.e., UE ID). For the above, the manager 39 exemplarily includes a management table (database) 391 that registers the MBMS receiving requirement information for each individual UE 50 as illustrated in FIG. 16. The manager 38 collects MBMS contents receiving requirement information from the respective UEs 50 and registers the collected information in the management table 391. FIG. 16 illustrates an example that a UE 50 having UE ID of #1 notifies by the MICH response that the UE 50 expects to receive the MBMS contents by the MICH response. The contents registered in the management table 391 can be appropriately overwrite and updated.

For example, if a UE 50 has a change in MBMS receiving requirement that the UE 50 previously notified to the BTS 10 by the MICH response, the UE 50 notifies the change to the BTS 10 by, for example, the MCCH response. The manager 39 causes the management table 391 to reflect the change. Namely, the manager 39 manages whether each UE 50 expects to receive the MBMS contents on the basis of the first information and the second information received by the receiver.

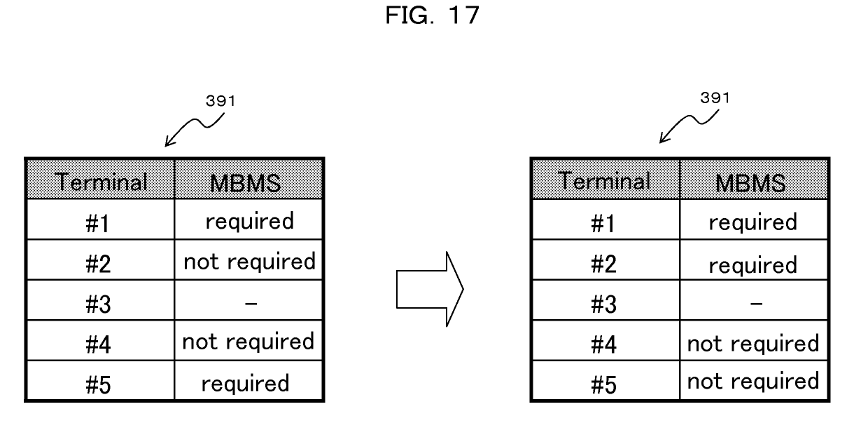

FIG. 17 illustrates an example of updating of the management table 391 when UE#2 and UE#5 among five UEs (having IDs #1 through #5) as illustrated in FIG. 10 change the receiving requirement.

Specifically, the entry of the UE#2, which previously notifies the BTS 10 that the UE does not expect to receive the MBMS contents but changes to expecting to receive the contents, is changed from “not required” to “required”. Conversely, the entry of the UE#5, which previously notifies the BTS 10 that the UE expects to receive the MBMS contents but changes to not expecting to receive the contents, is changed from “required” to “not required”. The entries of the remaining UEs 50 which makes no change in the MBMS requirement information remain unchanged.

When the data decoder 38 obtains powering-off operation information of a UE 50, the manager 39 deletes the entry having the UE ID of the UE 50. Furthermore, when the UE 50 is carrying out handover processing to another BTS (target BTS), the BTS 10 can recognize that the UE 50 is leaving the cell that the BTS 10 controls, and therefore updates (including deletion) the entry having the UE ID of the UE 50 to information representing the UE does not expect to receive the MBMS data any longer.

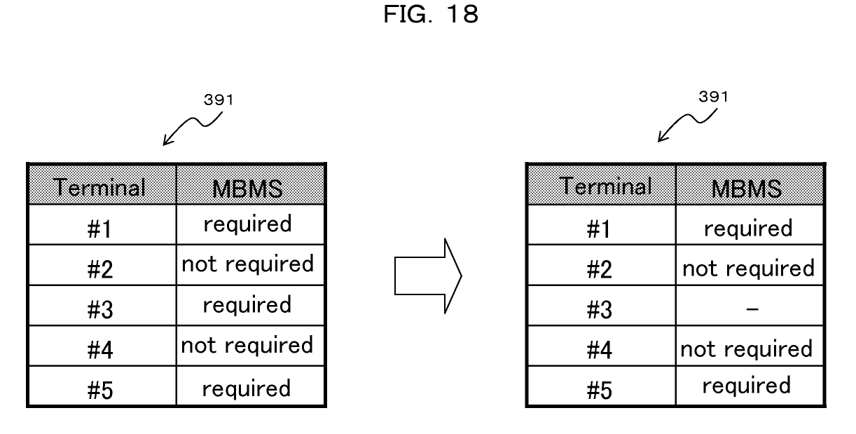

FIG. 18 illustrates an example of deleting the entry of a UE 50 having UE ID of #3, which has been managed to be a UE requiring to receive the MBMS contents but which is being powered off or is carrying out handover processing so that transmission of the MBMS contents to the UE#3 is not required any longer.

The scheduler 40 can grasp (recognize) the state of UEs 50 expecting to receive the MBMS contents (i.e., UEs that expect the receiving, and the number of the UEs expecting the receiving) by referring to the registered contents of the management table 391. The manager 39 is capable of sending a part or the entire part of the registered contents (e.g., information of UEs 50 that expect to receive the MBMS contents) to the upper layer (e.g., RNC or MBMS-GW), which makes the upper layer possible to count the number of UEs 50 that expect to receive the MBMS contents.

Furthermore, the scheduler 40 selects (schedules) a UE 50 with which the BTS 10 is to establish communication in obedience to a predetermined scheduling rule (parameter) on the basis of the control information provided from the control information decoder 36 and/or the result of CRC carried out by the data decoder 38. Examples of scheduling rule are Round Robin and PF (Proportional Fairness), but the rule should not be limited to these examples. The result of the scheduling is regarded as user allocation information, which is sent to the multiplexer 21.

In addition, the scheduler 40 sends information about, for example, retransmission control to the respective generators 111 through 115 on the basis of the control information provided from the 36. The scheduler 40 further determines the MCS information (encoding rate and modulation scheme) of the DL on the basis of the information related to transmission path quality such as CQI information, and sends the determined information to the respective generators 111 through 114 except for the RS generator 115.

The generator 11 exemplarily generates a RACH response, information of the MICH, information of the MCCH, information of the MTCH, and information of the RS. Specifically, a RACH response, information of the MICH, information of the MCCH, information of the MTCH, and information of the RS are generated by the RACH response generator 111, the MICH generator 112, the MCCH generator 113, the MTCH generator 114, and the RS generator 115, respectively.

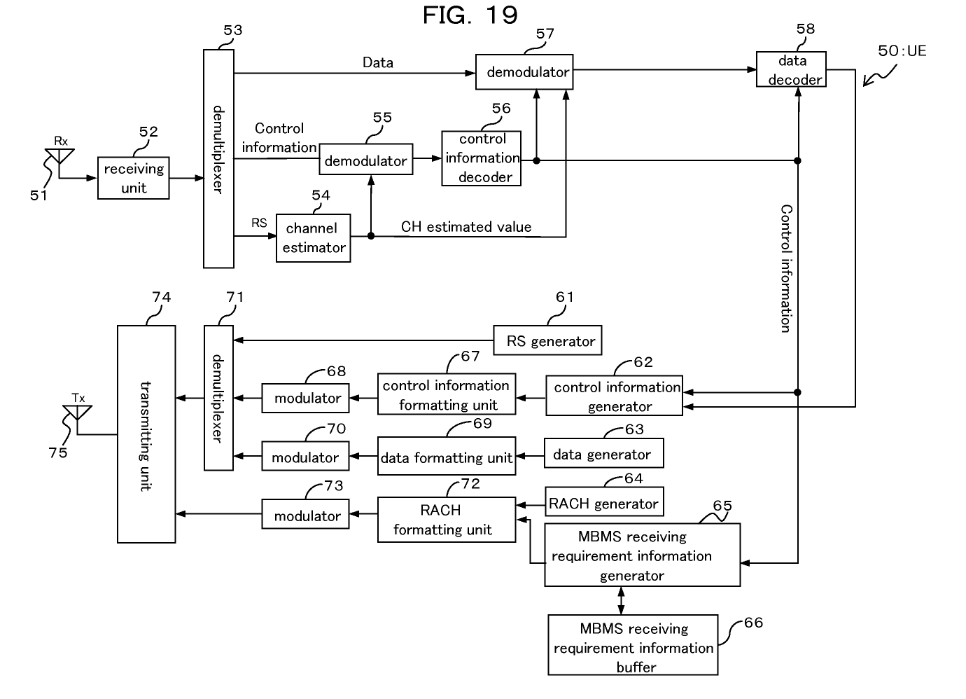

The MBMS contents (multimedia data such as music data and picture data) destined for the UEs 50 is included in the information generated by the MTCH generator 114. The RS generated by the RS generator 115 is used for DL channel estimation by the channel estimator 54 of a UE 50 illustrated in FIG. 19.

The formatting units 12, 14, 17, and 19 encode information generated by respective corresponding generators 111, 112, 113, and 114 on the basis of information of the encoding rate included in the MCS information.

The modulators 13, 15, 18, and 20 modulate information encoded by the respective corresponding formatting units 12, 14, 17, and 19 on the basis of the information of the modulation scheme included in the MCS information. In modulation, each modulator can attach a CRC code to the demodulating information. Examples of the modulation scheme are QPSK (Quadrature Phase Shift Keying), 16QAM (Quadrature Amplitude Modulation), and 64QAM.

The multiplexer 16 multiplexes a modulated signal of the RACH response and that of information of the MICH respectively obtained by the modulators 13 and 15, and generates a transmitting signal conforming to a predetermined transmitting frame format. Examples of multiplexing are OFDM (Orthogonal Frequency Division Multiplexing) and OFDMA (Orthogonal Frequency Division Multiple Access).

The multiplexer 21 multiplexes a modulated signal of information of the MTCH (including the MBMS contents) and the RS respectively obtained by the modulator 20 and the RS generator 115 on the basis of the result of scheduling by the scheduler 40, and generates a transmitting signal conforming to a predetermined transmitting frame format.

The transmitting unit 22 performs predetermined wireless transmission processing on transmitting signals obtained by the respective multiplexers 16 and 21, and the modulated signal of the MCCH obtained by the modulator 18. The wireless transmission processing exemplarily includes Digital-to-Analog (DA) conversion, frequency conversion to the wireless frequency (up conversion), and electric power amplification to a predetermined transmitting electric power.

The transmitting antenna 23 transmits a wireless DL signal obtained by the transmitting unit 22 to the UEs 50 accommodated in the cell (or the sector) that the BTS 10 controls. Here, the transmitting antenna 23 and the receiving antenna 31 may be shared by the transmission processor and the reception processor.

In other words, the block including the elements represented by reference numbers 11 (114), 19, and 20 through 23 is used as an example of a transmitter that transmits MBMS data under the control of the manager 39.

(1.3) UE50

FIG. 19 is a block diagram schematically illustrating an example of the configuration of the UE 50 of the first embodiment. The UE 50 of FIG. 19 exemplarily includes a receiving antenna 51, a receiving unit 52, a demultiplexer 53, a channel estimator 54, a demodulator 55, a control information decoder 56, a demodulator 57, and a data decoder 58, which collectively function as an example of a reception processor.

Besides, the UE 50 of the first embodiment exemplarily includes an RS generator 61, a control information generator 62, a data generator 63, a RACH generator 64, an MBMS receiving requirement information generator 65, an MBMS receiving requirement information buffer 66, a control information formatting unit 67, a data formatting unit 69, a RACH formatting unit 72, and modulators 68, 70, and 73, a multiplexer 71, a transmitting unit 74, and a transmitting antenna 75, which collectively function as an example of a transmission processor.

The receiving antenna 51 receives a wireless DL signal transmitted from the BTS 10.

The receiving unit 52 performs a predetermined wireless reception processing on a wireless DL signal received by the receiving antenna 51. The wireless reception processing exemplarily includes low-noise amplification, frequency conversion to the baseband frequency (i.e. down conversion) and Analog-to-Digital (AD) conversion.

The demultiplexer 53 separates an RS of DL, control signal, and data from the receive signal subjected to wireless reception procession in the receiving unit 52. The RS is input into the channel estimator 54, and the control signal is input into the demodulator 55. The control information includes, for example, the CQI information, the result of CRC, and the MCS information. The received data is input into the demodulator 57. The received data includes the result of CRC.

The channel estimator 54 obtains a DL channel estimated value based on the RS, and the obtained channel estimated value is provided to the demodulators 57 and 58.

The demodulator 55 demodulates the control information obtained by the demultiplexer 53 in a demodulation scheme (e.g., QPSK, 16QAM, or 64QAM) complying with the DL modulation scheme that the BTS 10 adopts. The result of the demodulation is input into the control information decoder 56.

The control information decoder 56 decodes the control information demodulated in the demodulator 55 in a decoding scheme and at an decoding ratio which comply with a DL encoding scheme (error correction encoding such as turbo encoding) and an encoding ratio that the BTS 10 adopts. The encoded control information is selectively provided to the demodulator 57, the data decoder 58, the control information generator 62, or the MBMS receiving requirement information generator 65, depending on the contents of the information.

The demodulator 57 demodulates the received data separated by the demultiplexer 53 on the basis of the channel estimated value from the channel estimator 54 and the control information (MCS information) from the control information decoder 56.

The data decoder 58 decodes the received data (e.g., RACH response, information of the MCCH, and information of the MTCH) demodulated in the demodulator 57 on the basis of the information of the encoding rate included in the MCS information from the control information decoder 56. The result of CRC included in the received data decoded is provided to the control information generator 62.

The RS generator 61 generates an RS of the UL. The generated RS is used for UL channel estimation by the channel estimator 34 of the BTS 10.

On the basis of information from the control information decoder 56 and the demodulator 57, the control information generator 62 generates the CQI information, the MCS information, and the result of CRC, which are examples of the control information.

The data generator 63 generates an UL transmitting data destined for the BTS 10. The RACH generator 64 generates information to be transmitted through the RACH. If the MICH response and the MCCH response are transmitted to the BTS 10 through the RACH, the RACH generator 64 generates information to be included in the respective responses.

The MBMS receiving requirement information generator 65 generates MBMS contents receiving requirement information.

The MBMS receiving requirement information buffer (memory) 66 stores the receiving requirement information that the MBMS receiving requirement information generator 65 generates. Accordingly, the MBMS receiving requirement information (first information) notified to the BTS 10 beforehand is stored in the buffer 66. Upon receipt of, for example, the information of the MCCH, the MBMS receiving requirement information generator 65 confirms the receiving requirement information stored in the buffer 66, and generates, if the stored first information is changed, updated MBMS receiving requirement information (second information) that is to be notified to the BTS 10.

In the first embodiment, MBMS receiving requirement information is exemplarily notified to the BTS 10 through the RACH. In the event of the notification, the receiving requirement information can be included in the message part of the RACH as illustrated in FIG. 11. However, the manner of notifying the receiving requirement information should by no means be limited to this. Alternatively, the MBMS receiving requirement information can be notified to the BTS 10 by signaling of an upper layer.

Conversely, if the MBMS receiving requirement information (first information) notified to the BTS 10 beforehand is not changed, the MBMS receiving requirement information generator 65 does not have to generate such updated MBMS receiving requirement information. Consequently, if the first information is not changed, the UE 50 stops transmission of a response (i.e., the MCCH response) to the inquiry (i.e., the MCCH) about whether the UE 50 expects to receive the MBMS. However, as illustrated in the example of FIG. 12, the MCCH response may be transmitted to the BTS 10, reducing the data amount of the MCCH response.

The control information formatting unit 67, the data formatting unit 69, and the RACH formatting unit 72 encode information generated, on the basis of the information of the UL encoding rate included in the MCS information, by the respective corresponding generators 62, 63, and 64. The UE 50 can adopt an error correction encoding scheme such as turbo encoding scheme to the encoding scheme.

The modulators 68, 70, and 73 modulate encoded information obtained by the respective corresponding formatting units 67, 69, and 72 on the basis of the information of the UL modulation scheme included in the MCS information. The UE 50 can adopt QPSK, 16QAM, and 64QAM to the modulation scheme.

The multiplexer 71 multiplexes the RS generated by the RS generator 61 and the modulated signals obtained by the modulators 68 and 70, and generates an UL transmitting signal conforming to a predetermined transmitting frame format. Examples of multiplexing are OFDM and OFDMA.

The transmitting unit 74 performs a predetermined wireless transmission processing on the multiplexed signal obtained by the multiplexer 71, and the modulated signal obtained by the modulator 73. The wireless transmission processing exemplarily includes Digital-to-Analog (DA) conversion, frequency conversion to the wireless frequency (up conversion), and electric power amplification to a predetermined transmitting electric power.

The transmitting antenna 75 transmits the wireless UL transmitting signal obtained by the transmitting unit 74 to the BTS 10. The transmitting antenna 75 and the receiving antenna 51 may be an integrated single form.

Namely, a block including the elements represented by reference numbers 64, 72, 73, 74, and 75 functions as an example of a transmitter that transmits first information (e.g., the MICH response) representing whether the UE 50 expects to receive the MBMS contents (data) before reception of an inquiry (e.g., the MCCH information) from the BTS 10 about whether the UE 50 expects to receive the MBMS contents.

The combination of the MBMS receiving requirement information generator 65 and the MBMS receiving requirement information buffer 66 function as an example of a controller that restricts transmission of the response (e.g., the MCCH response) to the inquiry received from the BTS 10 if the first information is not changed after the UE 50 transmits the first information.

The above configurations and the functions of the BTS 10 and the UE 50 can reduce the load on the UL channel when the number of the UEs expecting to receive the MBMS is counted through the MCCH. The advantages of the first embodiment will now be detailed below, comparing with a conventional method.

Conventional Method

Assuming that α % of the UEs (total number N) expects to receive the MBMS contents before the BTS transmits the MCCH to the UEs, N×α/100 UEs respond to the BTS.

Proposed method of the First Embodiment

Assuming that β % of the UEs (total number N) expects to receive the MBMS contents before the BTS transmits the MCCH to the UEs, the ratio of UEs that do not expect to receive the MBMS contents is (100−β) %. Further assuming that γ % among the UEs (β % ) that expects to receive the MBMS contents and δ % among the UEs (100−β) % that do not expect to receive the MBMS contents change the expect, N×β/100×γ/100+N×(100−β)/100×δ/100 UEs respond to the BTS 10.

In order to simplify these calculation, assuming that the changing ratios γ and δ are equal, N×γ/100 UEs respond to the BTS 10.

Here, the relationship aα>>γ makes the number of responding UEs in the first embodiment to be much less than that of the conventional manner. Reduction in the number of responding UEs can reduce the load on the UL channel.

According to the embodiments above, it is possible to reduce load caused by communication from a wireless device to a base station and also to reduce the processing load on the base station.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments have been described in detail, it should be understood that the various changes, substitutions, and alterations could be made hereto without departing from the spirit and scope of the invention.

What is claimed is:

1. A method for controlling communication in a wireless communication system in which a base station transmits data to a wireless device, the method comprising:
at the wireless device,
transmitting first information, representing whether the wireless device expects to receive the data, to the base station before receipt of an inquiry from the base station about whether the wireless device expects to receive the data, and
upon receipt of the inquiry from the base station, restricting transmission of a response to the inquiry to the base station if the first information is not changed.

2. The method according to claim 1, wherein the restricting comprises stopping transmission of second information to the base station, representing whether the wireless device expects to receive the data, as the response, or allowing the transmission of the second information while reducing a data amount of the second information.

3. The method according to claim 2, further comprising:
at the base station,
managing, on the basis of the first information and the second information received from the wireless device, whether the wireless device expects to receive the data from the base station.

4. The method according to claim 1, wherein the first information is transmitted to the base station during connection processing to establish communication between the base station and the wireless device.

5. The method according to claim 4, wherein the first information is transmitted to the base station, using a response to a channel through which the base station notifies that the data is available to be provided to the wireless device or using a signal of an upper layer than the channel.

6. The method according to claim 5, wherein information of the channel is transmitted, using a message transmitted from the base station to the wireless device during the connection processing.

7. The method according to claim 6, wherein the message is a random access response to a random access preamble transmitted from the wireless device to the base station.

8. The method according to claim 2, the second information is transmitted to the base station, using a response to a channel through which the base station transmits the inquiry to the wireless device or using a signal of an upper layer than the channel that the inquiry uses.

9. The method according to claim 2, wherein the second information is included in a random access preamble that the wireless device transmits to the base station after the wireless device receives the inquiry from the base station.

10. The method according to claim 4, wherein the connection processing including handover processing.

11. The method according to claim 1, further comprising:
at the wireless device,
upon being powered off or carrying out handover processing, notifying the base station of the powering off or the handover processing, and
at the base station,
upon receipt of the notifying from the wireless device, updating the first information received from the wireless device to information representing that the wireless device does not expect to receive the data.

12. A wireless device used in a wireless communication system in which a base station transmits data to the wireless device, the wireless device comprising:
a transmitter that transmits first information, representing whether the wireless device expects to receive the data, to the base station before receipt of an inquiry from the base station about whether the wireless device expects to receive the data; and
a controller that restricts transmission of a response to the inquiry that the wireless device receives from the base station after the transmitter transmits the first information to the base station if the first information is not changed.

13. The wireless device according to claim 12, wherein the restriction by the controller comprises stopping transmission of second information to the base station, representing whether the wireless device expects to receive the data, as the response or allowing the transmission of the second information while reducing a data amount of the second information.

14. The wireless device according to claim 12, wherein the transmitter transmits the first information to the base station during connection processing to establish communication between the base station and the wireless device.

15. The wireless device according to claim 13, wherein the transmitter transmits the second information to the base station, using a response to a channel through which the base station transmits the inquiry to the wireless device or using a signal of an upper layer than the channel that the inquiry uses.

16. The wireless device according to claim 13, wherein the transmitter puts the second information into a random access preamble that the wireless device transmits to the base station after the wireless device receives the inquiry from the base station.

17. The wireless device according to claim 14, wherein the connection processing including handover processing that the wireless device changes a base station that the wireless device is connecting to.

18. The wireless device according to claim 12, wherein, when the wireless device is being powered off or is carrying out handover processing, the controller notifies the base station of the powering off or the handover processing.

19. A base station used in a wireless communication system in which the base station transmits data to a wireless device, the base station comprising:
a receiver that receives first information, which represents whether wireless device expects to receive the data and which is transmitted from the wireless device before the base station transmits to an inquiry about whether the wireless device expects to receive the data to the wireless device, and that receives second information transmitted from the wireless device after the base station transmits the inquiry to the wireless device if the first information is changed;
a manager that manages, on the basis of the first information and the second information received from the wireless device, whether the wireless device expects to receive the data from the base station; and
a transmitter that transmits the data under the control of the manager.

20. The base station according to claim 19, wherein:
the receiver receives a notification of powering off or handover processing from the wireless device; and
the manager updates, upon receipt of the notification from the wireless device, the first information previously received from the wireless device, to information representing that the wireless device does not expect to receive the data.
